(19) United States
(12) Patent Application Publication
(10) Pub. No.: US 2016/0316377 A1
(43) Pub. Date: Oct. 27, 2016

(54) METHOD AND SYSTEM FOR ESTIMATING A TOPOLOGY OF A NETWORK AND ITS USE IN A MOBILE AD HOC RADIO NETWORK

(71) Applicant: THALES CANADA INC., Toronto (CA)

(72) Inventor: Keith Edward HOOEY, Kanata (CA)

(73) Assignee: Thales Canada Inc., Toronto, ON (CA)

(21) Appl. No.: 15/105,261

(22) PCT Filed: Dec. 12, 2014
(86) PCT No.: PCT/CA2014/000898

§ 371 Date: Jun. 16, 2016

Related U.S. Application Data
(60) Provisional application No. 61/918,956, filed on Dec. 20, 2013.

(51) Int. Cl. H04W 16/18; H04W 64/00; H04L 12/24

(52) U.S. Cl. CPC H04W 16/18; H04L 41/12; H04W 64/003

(57) ABSTRACT

A method for estimating a radio network topology at a given node of a plurality of nodes, defining a radio network, located in a deployment zone. The method includes obtaining a position of the given node and at least one other node from the plurality of nodes; obtaining elevation data in the deployment zone; for each two given nodes selected from the given node and the at least one node from the plurality of nodes, computing a total radio path loss estimate between the two given nodes using part of the elevation data; comparing the computed total radio path loss estimate and a corresponding maximum permissible path loss value between the two given nodes to determine if a given radio link between the two given nodes is possible; storing an indication of the radio link possibility; and generating the estimated radio network topology using the stored indications.

### CROSS-REFERENCE TO RELATED APPLICATIONS

This application claims priority on U.S. Application No. 61/918,956, filed on Dec. 20, 2013, which is incorporated herein by reference.

### FIELD

The invention relates to telecommunications. More precisely, the invention pertains to a method and apparatus for estimating a topology of a mobile ad hoc network and its use to route traffic across such a network.

### BACKGROUND

Mobile ad hoc tactical radio networks (MANETs) are used for instance by military and paramilitary ground forces.

Each node in the network typically comprises radio equipment which is a transceiver that alternately sends or receives traffic which may be voice or data. The radio equipment typically uses vertical whip antennas with omnidirectional coverage in azimuth such as are commonly used with mobile radio systems.

Those networks usually operate in the VHF or UHF radio bands.

The tactical nature of the networks is such that they communicate with each other without the benefit of fixed infrastructure such as fixed elevated relay towers, or fixed sites with routers and switches, that are typical of cellular radio telephone and data systems. It is the lack of dependence on infrastructure of such networks that makes them ad hoc.

As a consequence, the ability of each node to reach any or all other nodes is dependent on ad hoc relaying of traffic by intermediary user nodes that are configured to relay traffic when they are not being used to send or receive local user traffic.

It will be appreciated that the need for relay services is determined by the distance between the nodes and by the nature of the surface terrain that lies between the nodes, sometimes aiding reception when nodes are located on high ground, or sometimes inhibiting reception when nodes are located in low-lying areas.

A common approach used by various systems to solve the problem is to employ the Optimized Link State Routing (OLSR) protocol, as disclosed in “Optimized Link State Routing (OLSR) protocol,” Request for Comments 3626, Internet Engineering Task Force, or some variant thereof.

In these prior-art mobile ad hoc tactical radio networks, the connectivity among the nodes is periodically measured by a process where each node uses a portion of its transmission bandwidth to send a “hello” message, one after another in a round-robin fashion, that includes its unique ID and a list of its detected one-hop neighbors.

Other nodes detecting such “hello” messages can form a view of the network topology and use this to compute possible relay nodes to reach destinations that are not reachable by a direct radio path.

The skilled addressee will appreciate that this process requires multiple rounds of “hello” message exchanges and the network management traffic overhead grows as the square of the network size, N, where N is the number of active nodes in the network. This is sometimes referred to as the “N-squared” problem in network theory. In the case of networks comprised of more than ten (10) nodes, this becomes a significant burden on operational efficiency. In fact, more and more of the available bandwidth then becomes consumed by nodes trying to discover or maintain a current view of the network topology.

It will also be appreciated by the skilled addressee that the exchange of “hello” messages takes time. As a consequence, if the process involving sending in a round-robin fashion “hello” message becomes too slow, as a result of having a large number of nodes, and if the topology of the network of nodes evolves, the measured topology may quickly become outdated.

There is a need for a method for estimating a network topology of a radio system that will overcome at least one of the above-identified drawbacks.

Features of the invention will be apparent from review of the disclosure, drawings and description of the invention below.

### BRIEF SUMMARY

According to a broad aspect, there is disclosed a method for estimating, at a given node of a plurality of nodes located in a deployment zone and defining a radio network, a topology of the radio network, the method comprising obtaining a position of the given node; obtaining a position of at least one other node from the plurality of nodes; obtaining elevation data in the deployment zone; for each two given nodes selected from a group consisting of the given node and the at least one node from the plurality of nodes; computing an estimate of a total radio path loss between the two given nodes using at least one part of the elevation data; comparing the computed estimate of the total radio path loss between the two given nodes and a corresponding maximum permissible path loss value between the two given nodes to determine if a given radio link between the two given nodes is possible; storing an indication of the possibility of having a radio link between the two given nodes and generating the estimation of the topology of the radio network using the stored indications of the possibility of having a radio link.

According to an embodiment, the obtaining of the position of the given node comprises receiving the position from a global positioning system (GPS) receiver.

According to an embodiment, the obtaining of the position of the given node comprises performing a radio trilateration and providing a position resulting from the radio trilateration.

According to an embodiment, the obtaining of the position of the given node comprises computing a position using dead-reckoning principles from a reference point.

According to an embodiment, the indication of the possibility of having a radio link between the two given nodes comprises one of an indication that the radio link between the two given nodes is possible and an indication that the radio link between the two given nodes is not possible.

According to an embodiment, the position of the given node is obtained locally.

According to an embodiment, the position of the given node is obtained from a remote location.

According to an embodiment, the obtaining of a position of at least one other node from the plurality of nodes comprises for each of the at least one other node obtaining a corresponding position and transmitting the corresponding position to the given node.

According to an embodiment, the obtaining of a corresponding position comprises using a global positioning system (GPS) receiver.

According to an embodiment, the obtaining of a corresponding position comprises performing a radio trilateration and providing a position resulting from the radio trilateration.

According to an embodiment, the transmitting of the corresponding position to the given node comprises providing an identification of the corresponding node transmitting the corresponding position.

According to an embodiment, the identification of the corresponding node comprises a media access control (MAC) address of the corresponding node.

According to an embodiment, the obtaining of the elevation data comprises accessing a file with a corresponding position and obtaining a corresponding elevation data associated with the corresponding position.

According to an embodiment, the estimate Plex of a total radio path loss between the two given nodes is equal to Plex=32.4+20×log(f)+20×log(D)+A(dB)+EX(dB), wherein f is an operating frequency in MHz, D is a distance between the two given nodes in kilometres, A is an allowance for fading and EX is an excess loss value.

According to an embodiment, the corresponding maximum permissible path loss value between the two given nodes is equal to Pl(max)=Pt−SNR(min)−No, wherein Pt is a power transmitted, SNR(min) is a ratio of signal power to noise at a receiver and No is a level of noise present at a receiver.

According to a broad aspect, there is disclosed a system for operating a radio at a given node of a plurality of nodes located in a deployment zone and defining a radio network, the system comprising an elevation data providing unit for providing elevation data for a given position; a position data providing unit for providing a position of the given node; a radio environmental data providing unit for providing radio environmental data associated with the given node; a network topology estimation unit operatively connected to the elevation data providing unit, to the position data providing unit and to the radio environmental data providing unit, the network topology estimation unit obtaining the position of the given node from the position data providing unit; the network topology estimation unit further obtaining a corresponding position of at least one other node from the plurality of nodes; the network topology estimation unit further obtaining the elevation data in the deployment zone from the elevation data providing unit; for each two given nodes selected from a group consisting of the given node and the at least one node from the plurality of nodes, the network topology estimation unit computing an estimate of a total radio path loss between the two given nodes using at least one part of the elevation data, comparing the computed estimate of the total radio path loss between the two given nodes and a corresponding maximum permissible path loss value between the two given nodes to determine if a given radio link between the two given nodes is possible and storing an indication of the possibility of having a radio link between the two given nodes to provide an estimation of a network topology; a node routing determining unit operatively coupled to the network topology estimation unit and, the node routing determining unit for generating a routing table using the estimation of a network topology and radio management unit operatively connected to the node routing determining unit, the radio management unit for managing the radio using the estimation of the network topology.

According to an embodiment, the position data providing unit comprises a global positioning system (GPS) receiver.

According to an embodiment, the routing table determined by the node routing determining unit comprises an indication of at least one node member of a connected dominating set.

According to an embodiment, the routing table determined by the node routing determining unit comprises an indication that the given node is a gateway.

According to a broad aspect, there is disclosed a storage device for storing programming instructions executable by a processor, which when executed will cause the execution by the processor of a method for estimating, at a given node of a plurality of nodes located in a deployment zone and defining a radio network, the method comprising obtaining a position of the given node; obtaining a position of at least one other node from the plurality of nodes; obtaining elevation data in the deployment zone; for each two given nodes selected from a group consisting of the given node and the at least one node from the plurality of nodes; computing an estimate of a total radio path loss between the two given nodes using at least one part of the elevation data; comparing the computed estimate of the total radio path loss between the two given nodes and a corresponding maximum permissible path loss value between the two given nodes to determine if a given radio link between the two given nodes is possible; storing an indication of the possibility of having a radio link between the two given nodes and generating the estimation of the topology of the radio network using the stored indications of the possibility of having a radio link.

An advantage of the method disclosed herein is that no bandwidth is required to manage relay functions since each node is capable of determining by itself an estimation of the network topology and use it for routing purposes.

Another advantage of the method disclosed herein is that an estimation of the network topology may be obtained more quickly than using prior-art methods. A consequence will be that the estimation of the topology of the network will be more accurate in the case where the topology evolves than if “hello” messages were used to determine it.

Another advantage of the method disclosed is that the method is particularly useful for networks that operate without a central controlling node.

Another advantage of the method disclosed is that a node will therefore have more bandwidth for transmitting voice or data than if “hello” messages are used for determining the topology of the network.

In one embodiment of the invention, each node estimates the degree of path obstruction with other known nodes, and between other known nodes, using terrain elevation data embedded in the radio or in an attached ancillary computing device, along with known or estimated geographical distribution of noise and interference. From these estimates of radio path loss and noise, each node can compute the feasibility of delivering traffic to other nodes either directly or via relays without the need to exchange “hello” messages conventionally used to discover connectivity in such networks. The nodes can determine by themselves if they have to act as relays or not using their own computations.

### BRIEF DESCRIPTION OF THE DRAWINGS

In order that the invention may be readily understood, embodiments of the invention are illustrated by way of example in the accompanying drawings.

FIG. 1 is a diagram which shows an example of a mobile ad hoc radio network comprising a plurality of nodes.

FIG. 2 is a flowchart which shows an embodiment of a method for estimating a topology of a network.

FIG. 3 is a graph which shows an estimation of the diffraction of radio waves over various obstacles.

FIG. 4 is a diagram which shows an example of a path profile between a transmitter and a receiver located 50 km away from the transmitter.

FIG. 5 is a routing table for node 8 of the network of nodes shown in FIG. 1.

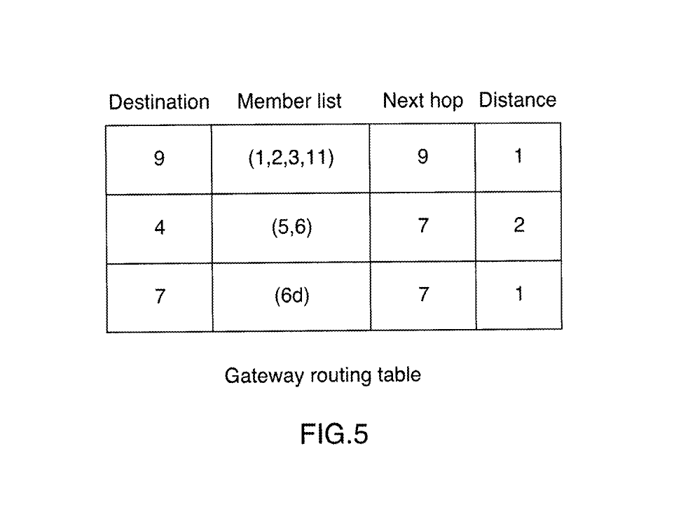

FIG. 6 is a flowchart which shows an embodiment for obtaining a position of at least one other node.

FIG. 7 is a diagram which shows an embodiment wherein the method for estimating the topology of a network is used for the purpose of operating a radio.

Further details of the invention and its advantages will be apparent from the detailed description included below.

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

The term “variation” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus does not limit the term or phrase it explains. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

The term “respective” and like terms mean “taken individually.” Thus, if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is,” and thus limits the term or phrase it explains. For example, in the sentence “the computer sends data (i.e., instructions) over the Internet,” the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g. 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to,” the mere usage of the phrase “including but not limited to” does not mean that the term “including” means something other than “including but not limited to.”

Various embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

As disclosed below, the invention may be implemented in numerous ways.

With all this in mind, the present invention is directed to a method and system for estimating a topology of a network and its use in a mobile ad hoc radio network.

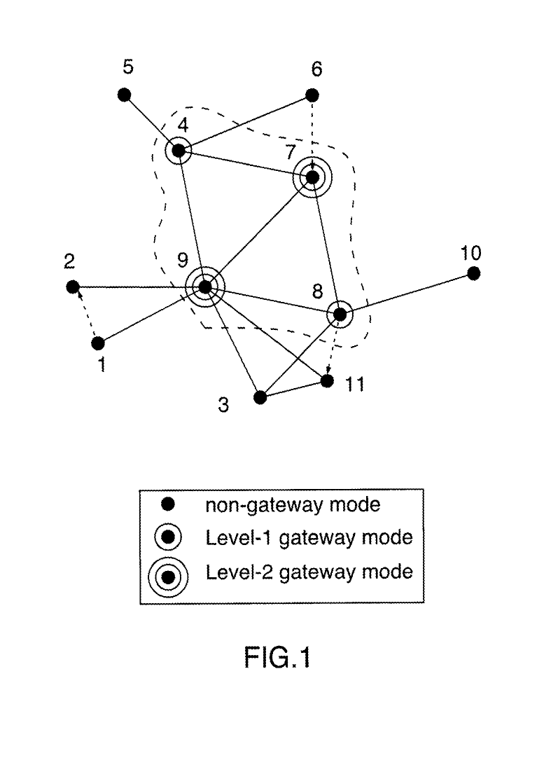

Now referring to FIG. 1, there is shown an example of a network comprising a plurality of nodes. It will be appreciated that the network is a mobile ad hoc radio network. In an alternative embodiment, the network is a mixed type network where some nodes are connected via infrastructure such as a central tower or a satellite relay, or some other form of fixed or stationary relay, for example a tethered aerostat, and others are not. The latter nodes depend on ad hoc relaying to reach the infrastructure portion of the network.

In fact, in military and emergency radio networks, the persistent exchange of node positions, often derived from GPS receivers, is a key part of the user traffic. The node locations are entirely contained within a well defined area of operations.

In one embodiment, the dimensions of the area of operations are significantly greater than the radio range achieved by a typical transmission. As a consequence, the nodes will not be in direct contact with all other nodes given this condition.

For instance, it will be appreciated that a typical area of operations might be that represented by a 1:50,000 topographic map sheet covering an area 41×27 kilometers (at middle latitudes).

It will be further appreciated that the nodes use VHF or UHF radios dispersed over the full extent of an area of operations of this size will not be able to communicate with all other nodes given the basic blockage due to the earth's curvature. Also, additional terrain features such as hills and valleys may further exacerbate connectivity among nodes, particularly when the nodes are constantly moving for tactical or operational reasons.

The method disclosed herein operates from the premise that each node of the network has a priori knowledge of the number of nodes in the network.

In this embodiment, the network comprises eleven (11) nodes. More precisely, the network comprises node 1, node 2, node 3, node 4, node 5, node 6, node 7, node 8, node 9, node 10 and node 11.

It will be appreciated that in certain cases a radio link is possible in both ways between certain nodes.

For instance, there is a possible radio link in both ways between node 1 and node 9, between node 2 and node 9, between node 3 and node 9, between node 11 and node 9, between node 8 and node 9, between node 7 and node 9 and between node 4 and node 9.

It will be appreciated that in other cases there is no radio link possible between certain nodes.

For instance, there is no radio link possible between the node 2 and node 5, between node 1 and node 3, between node 10 and node 11, between node 10 and node 7, etc.

It will be further appreciated that in certain cases, the radio link between two nodes is limited to a transmission in a given direction.

The skilled addressee will appreciate that this may be due for instance to the fact that a jammer, or some other source of radio interference, is used in the vicinity of the node. In such case, the node may be able to transmit to a remote node but may not be able to receive a signal from the remote node.

For instance, there is a radio link limited to one given direction between node 1 and node 2. More precisely and in this embodiment, the transmission can only be done from node 1 to node 2. No transmission can be performed from node 2 to node 1.

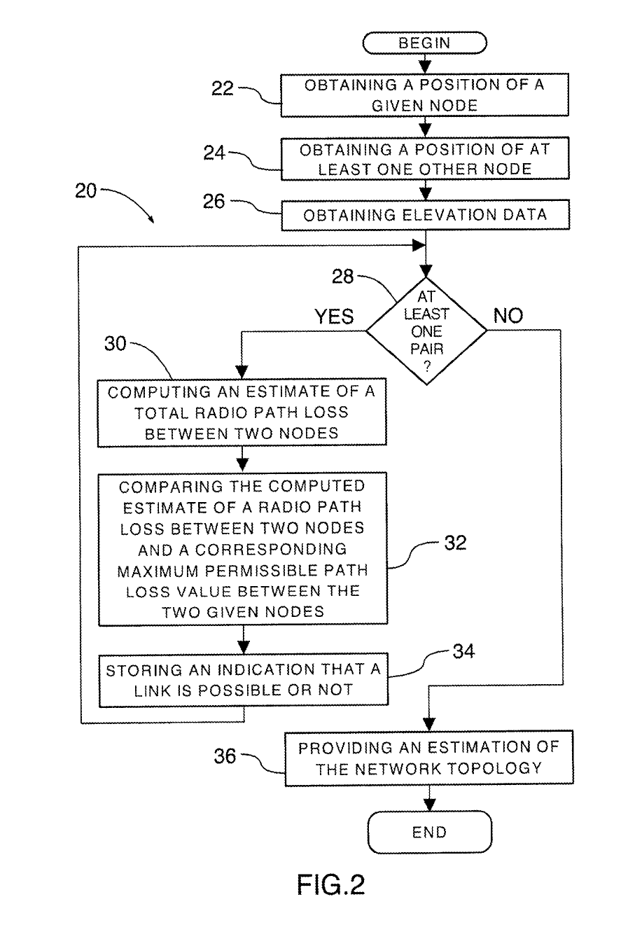

Now referring to FIG. 2, there is shown an embodiment of a method for estimating a topology of a network.

According to processing step 22, a position of a given node is obtained.

It will be appreciated that the position of the given node may be obtained according to various embodiments.

In one embodiment, the position of the given node is obtained from a global satellite positioning system such as GPS using a local receiver.

Alternatively, the position of the given node is obtained from some form of radio trilateration where radio nodes measure the time of arrival of signals from other nodes and thereby compute location coordinates of itself or other nodes relative to at least one node (possibly itself) where at least one node's location is known relative to the earth's surface, as expressed by latitude and longitude or some other coordinate system that can be easily converted to latitude and longitude. Another possibility is that nodes compute their locations based on dead-reckoning principles from a known reference point, and then report this position as part of their radio traffic. Yet another possibility is that nodes are expected to be at or near certain reference points at certain points in time according to a previously agreed movement plan. Rates of movement can be used to estimate intermediate positions. Yet another possibility is that nodes are tracked by some other tracking system and are then advised what their coordinates are.

In fact, it will be appreciated that the position of the given node may be obtained locally in one embodiment. In another embodiment, the position of the given node is obtained from a remote location.

According to processing step 24, a position of at least one other node is obtained.

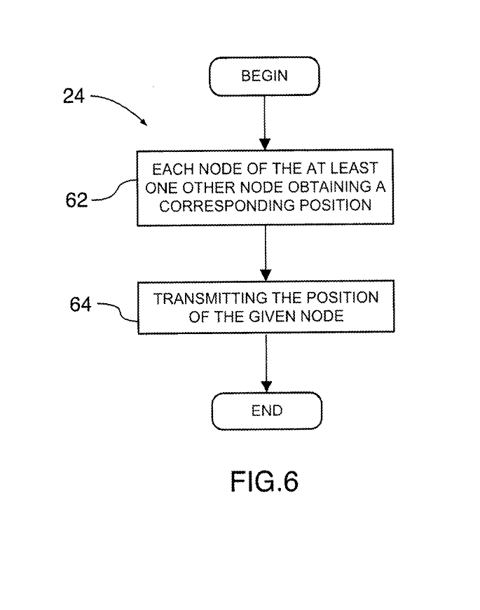

Now referring to FIG. 6, there is shown an embodiment for obtaining a position of at least one other node.

According to processing step 62, each of the at least one other node is obtaining its position.

It will be appreciated by the skilled addressee that the position may be obtained according to various embodiments.

In one embodiment, the position of each of the at least one other node is obtained from a corresponding global positioning system (GPS) receiver.

Alternatively, the position of each of the at least one other node is obtained from radio trilateration.

In fact, it will be appreciated that the position of the given node may be obtained locally in one embodiment. In another embodiment, the position of the given node is obtained from a remote location.

Alternatively, the position of each of the at least one other node is obtained from a dead-reckoning navigation device.

According to processing step 64, each of the at least one other node is transmitting its position to the given node.

It will be appreciated that the transmission may be performed according to various embodiments.

In one embodiment, the position of each of the at least one other node is transmitted together with an identification of the corresponding node transmitting it.

In one embodiment, the identification of the node transmitting it comprises its media access control (MAC) address. The transmissions from nodes may also be associated with a specific node by its time of transmission, or some other attribute of the transmitted signal as may be defined in a system configuration plan.

The skilled addressee will appreciate that the transmission of the position of a given node together with its identification may be performed via a number of intermediary nodes between the transmitting node and the receiving node.

Now referring back to FIG. 2 and according to processing step 26, elevation data is obtained.

It will be appreciated that the elevation data is provided for the area of operations, also referred to as a deployment zone.

It will be appreciated that the elevation data may be provided according to various embodiments.

The skilled addressee will appreciate that the elevation data is commonly provided by various government agencies as Digital Terrain Elevation Data (DTED) or, in Canada, a Canadian Digital Elevation Data (CDED). The elevation data are provided in such embodiments as text files, defined by the mapping agencies, that contain long lists of numbers representing the terrain elevation in meters above the earth's reference geoid. It will be appreciated that the reference geoid is a mathematical concept that represents the approximate height of the sea surfaces above earth's center and the fact that the earth is not quite spherical in shape. Each elevation data value represents the elevation at a “post position” that is defined with some precision by its latitude and longitude.

In one embodiment, Digital Terrain Elevation Data or Canadian Digital Elevation Data are used. The data represents a 2-dimensional array of post positions at separations of 75 arc-seconds that correspond to distances of about 25 meters in the east-west and north-south direction, at mid-latitudes.

It will be appreciated that a typical Digital Terrain Elevation Data/Canadian Digital Elevation Data file contains an array of 1201×1201 post positions containing approximately 1.4 million elevation values. Two of these files representing two adjacent areas of the earth's surface in the east-west direction correspond to the area covered by a standard 1:50,000 topographic map sheet.

It will be appreciated that the data is organized in these files in such a manner that the post position latitude and longitude for each value can be inferred from the position of the value in the file and from a knowledge of the latitude and longitude of the southwest corner of the associated map sheet. Larger or smaller areas can easily be represented by adjusting the size of the data files to be used.

It will be appreciated that the use of latitude and longitude to describe the area of operations and the post spacings ensures that the Digital Terrain Elevation Data or the Canadian Digital Elevation Data can be used anywhere on the surface of the earth.

It will be appreciated that in tactical military radio systems the exchange of node positions is a key component of the user traffic, and the positional awareness is constantly being refined by the user traffic.

It will be appreciated that the elevation data obtained from various mapping agencies may be compressed using suitable formats to file sizes that are an order of magnitude smaller than the verbose text formats typically used. As a consequence, large areas can then be easily stored in flash memory within software-defined radios or ancillary computing devices.

According to processing step 28, a test is performed in order to find out if there is at least one pair of nodes for which a determination of the possibility of having a radio link has not been done yet.

In the case wherein there is at least one pair of nodes for which a determination of a possibility of having a radio link has not been done yet and according to processing step 30, an estimate of a total radio path loss between the two nodes is computed.

It will be appreciated that by the skilled addressee that the estimate of a total radio path loss between the two nodes may be computed according to various embodiments.

In one embodiment, the estimate of a total radio path loss Plex between the two nodes is computed as follows.

Plex(dB)=32.4+20×log(f)+20+log(D)+A(dB)+EX(dB) [5]

The factor f is the operating frequency in MHz, D is the distance between the two nodes in question, in kilometres (km), A is an allowance for fading, usually in the range of 5-12 dB, and EX is the excess loss value.

In one embodiment, the excess loss value EX is computed using Wong's technique. Wong's technique is disclosed in “Field strength prediction in irregular terrain-the PTP model,” a report attached to a notice of proposed rulemaking submitted in 1998 to the FCC by Harry K. Wong.

It will be appreciated by the skilled addressee that the excess loss value EX as well as the estimate of a total radio path loss Plex may be determined according to another embodiment that in some manner incorporates terrain elevation data into the calculation of excess path loss.

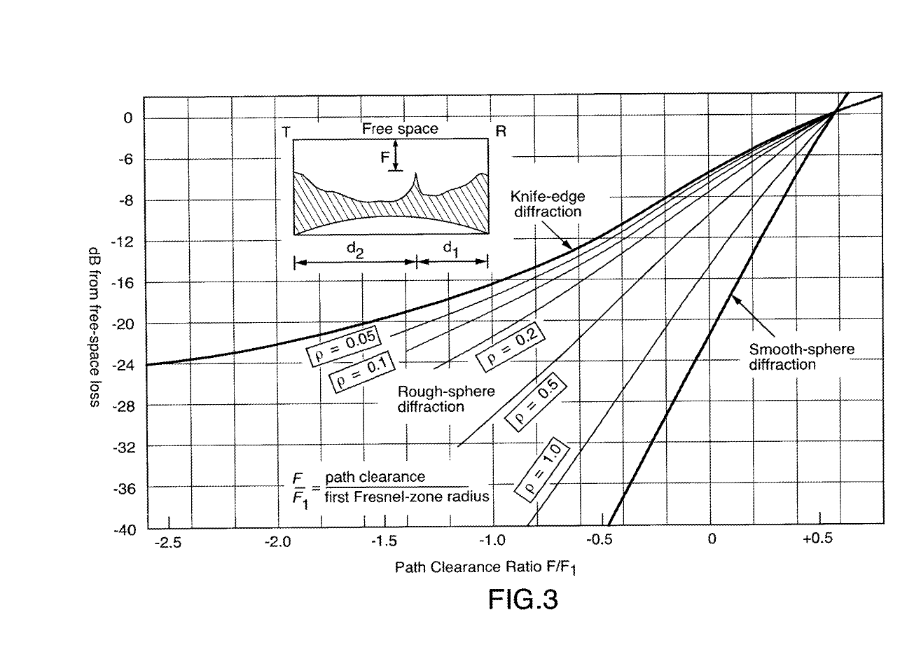

Now referring to FIG. 3, there is shown a graph which discloses the diffraction of radio-waves over various obstacles.

The ordinate values are predicted excess loss to be added to a simple line-of-sight (LOS) estimate based on the Friis transmission equation where path loss is obtained as a function of the square of the operating frequency and the square of the straight line distance between transmitter and receiver.

The abscissa is the available clearance, possibly negative, over the highest obstructing terrain point between the transmitter and the receiver. The value is expressed as a ratio of the clearance to the first Fresnel zone clearance, F1, at that point.

It will be appreciated that the greater the incursion of the obstruction into the first Fresnel zone clearance F1, the greater the excess path loss.

It will be appreciated that the diffraction is shown by a set of curves with a parameter that varies from 0 to 1 and that represents the smoothness or roughness of the obstruction in the vicinity of the highest obstruction.

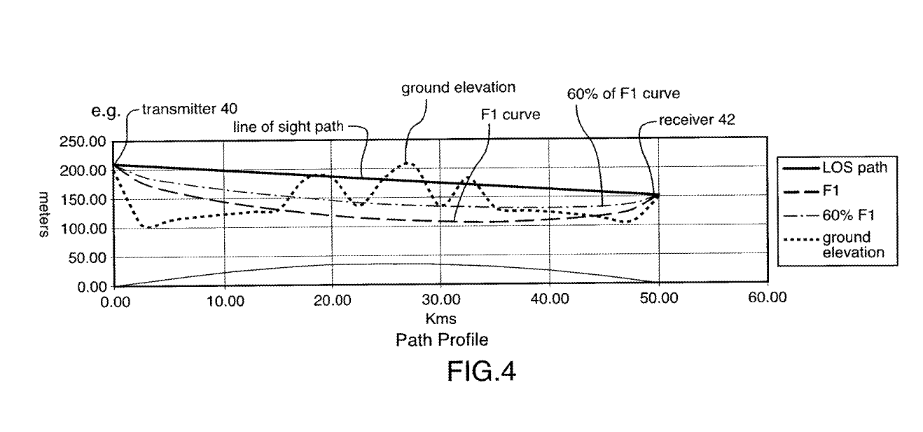

Now referring to FIG. 4, there is shown an example of a path profile between a transmitter 40 and a receiver 42 located 50 km away from the transmitter 40.

As shown in FIG. 4, there is an obstruction of the line of sight (LOS) due to the profile of the terrain.

It will be appreciated that the profile of the terrain, also referred to as ground elevation in FIG. 4, between the transmitter 40 and the receiver 42 is adjusted for the earth's curvature.

It will be appreciated that in this example, the highest point on the profile of the terrain slightly blocks the radio path at a distance of about 27 km from the transmitter 40.

It will be further appreciated by the skilled addressee that the obstruction value and the terrain roughness between the transmitter 40 and the receiver 42 can be estimated given the position and therefore distance between the transmitter 40 and the receiver 42, the operating frequency of the radio link and the terrain elevation data between the transmitter 40 and the receiver 42.

These values can be then used to obtain an estimate of the excess path loss using the model disclosed in FIG. 3.

It will be appreciated that the first three terms on the right of equation [5] are from the Friis transmission equation for line of sight (LOS) conditions.

Moreover, the allowance for fading A is commonly included to allow for statistical variations in multi-path fading, and the factor EX is included here to allow for excess path loss due to diffraction losses as described above.

Still referring to FIG. 2 and according to processing step 32, a comparison is performed between the computed estimate of the total radio path loss between the two given nodes and a corresponding maximum permissible path loss value between the two given nodes to determine if a given radio link between the two given nodes is possible.

In fact, it will be appreciated that the corresponding maximum permissible path loss value may be computed as follows.

The power received at a receiver Pr, in dBm, from a transmitter sending at power Pt, in dBm, over a path with signal loss measured or calculated to be Pl, in dB may be defined as:

Pr=Pt−Pl [1]

The ratio of signal power to noise power SNR at a receiver, in dB, may be defined as a function of the power received at the receiver Pr and of the level of noise present at the receiver No, in dBm, and more precisely as:

SNR=Pr−No [2]

It will be appreciated that the level of noise present at the receiver No is the level of the noise present at the receiver from at least one of an internal source and an external noise source, or some combination of the two.

It will be appreciated that the ratio of signal power to noise power SNR may be expressed in logarithmic form as:

SNR=Pt−Pl−No [3]

This expression of the signal power to noise power SNR is derived from the equations [1] and [2].

It will be appreciated by the skilled addressee that for any given radio, the minimum value of the signal power to noise power SNR required for a radio link to be usable is determined from the waveform (modulation and coding) techniques in use.

In fact, for many VHF or UHF radio systems, the required signal power to noise power SNR will be in the range of 10-25 dB. The skilled addressee will appreciate that smaller or greater values may be possible.

The value of the level of noise present at the receiver No may also be well known for various operating locations and conditions, including where a military node is collocated with an CIED jammer for instance.

A maximum permissible path loss value, in dB, may be determined by rearranging the terms of the equation [3].

Pl(max)=Pt−SNR(min)−No [4]

By comparing the estimate of a total radio path loss Plex between the two nodes and the maximum permissible path loss value Pl(max), it is possible to find out if a radio link is possible between the two nodes.

More precisely, it will be appreciated that a radio link is possible between the two nodes in the case where the estimate of a total radio path loss Plex is smaller than the maximum permissible path loss value Pl(max).

It will be appreciated that the determination must be performed for the two directions of radio transmission between two given nodes. As explained above, while a radio link may be possible in one direction between two nodes, a radio link may be not possible in the other direction between the two same nodes.

Still referring to FIG. 2 and according to processing step 34, an indication of the possibility of having a radio link between the two given nodes is stored. It will be appreciated that the indication of the possibility of having a radio link may comprise one of the possibility of having a radio link and the possibility of not having a radio link between the two given nodes.

It will be appreciated that the indication may be stored according to various embodiments known to the skilled addressee.

It will be appreciated that the estimation of the network topology is provided according to processing step 36, once all possible radio links have been analyzed.

It will be appreciated that the objective of the method disclosed is to continually recalculate the path loss between all pairs of nodes including itself and form an evolving view of the topology.

As and when a node moves, all radio links with that node will be re-estimated by all other nodes that are aware of that movement. Hence, the application of terrain analysis is a distributed one, and also a near-real-time one to permit all nodes to maintain a nearly common and up-to-date view of topology. The skilled addressee will appreciate that aside from transmitting the positions of the nodes, no system bandwidth is required to estimate the topology of the network.

The skilled addressee will appreciate that the estimation of the network topology may then be used to determine a routing table for the given node.

It will be further appreciated that in one embodiment, the estimation of the network table is continuously performed to ensure its accuracy.

The skilled addressee will appreciate that the method disclosed herein enables the nodes to be locally aware of the terrain they are operating in and each has local access to a data file representing terrain elevations, or the propagation effects of the terrain, that it can use to calculate estimates of the network topology.

It will therefore be appreciated that the concept of exchanging “hello” messages using network bandwidth to determine topology is replaced with a concept of calculating topology using other readily available information.

It will be appreciated by the skilled addressee that it is possible for each node to identify, using the estimation of the topology and using the algorithms listed herein below, a minimal subset of nodes that are connected with each other and to provide a connection to nodes that are not part of that set.

Jie Wu and Hailan Li, “A Dominating-set-based routing scheme in Ad Hoc Wireless Networks,” Telecomm Systems, a special issue on Wireless Networks, vol. 18, No. 1-3, pp. 13-36, 2001.

Jie Wu “Extended dominating-set-based routing in Ad Hoc Wireless Networks with Unidirectionals Links,” IEEE Trans. On Parallel and Distributed Systems, vol. 13, No. 9, September 2002.

Ivan Stojmenovic, Mahtab Seddigh, and Jovia Zunic “Dominating sets and neighbor elimination-based broadcasting algorithms in Wireless networks,” IEEE Trans. On Parallel and Distributed Systems, vol. 12, No. 12, December 2001, and subsequent corrections vol 15, No. 11, November 2004.

It will be appreciated by the skilled addressee that the connected set is referred to here and in related literature as a connected dominating set (CDS).

Nodes that are members of the connected dominating set can compute for themselves that they are member of that set.

Other nodes can compute for themselves that they are not part of the connected dominating set, but are connected to at least one node member of the connected dominating set.

This particular view of the topology enables the node members of the connected dominating set to know that they must relay traffic to and from non-connected dominating set node members when they hear such transmissions.

The skilled addressee will appreciate that this is quite different from the “source determined” relaying function disclosed in the Optimized Link State Routing protocol.

The connected dominating set calculation mechanism, based entirely on local computations replaces the “hello” message exchanges to achieve a connected or nearly connected network result.

Cleary, a node that cannot reach a node member of the connected dominating set cannot reach all members of a net, and may not be able to reach any other member.

There is an implicit boot-strap mechanism in play in the embodiment of the method disclosed. The nodes that are members of the connected dominating set can easily determine their connected dominating set membership because they are well connected with other nodes that are members of the connected dominating set and can easily determine their locations.

Nodes that are non-members of the connected dominating set need only to concern themselves with knowing the state of their connection(s) with at least one node member of the connected dominating set.

Position data being broadcast by all node members as part of the user traffic is resent by nodes that are members of the connected dominating set as required so that virtually all network members have PA and thus compute most, if not all, links states, using elevation data and a suitable path profile analysis algorithm.

The nodes that are members of the connected dominating set have a complete or nearly complete and common view of the network topology. Nodes that are not members of the connected dominating set have a less complete view of the topology, and do not need a complete view to deliver user traffic. Those nodes only need to reach a node member of the connected dominating set. The connected dominating set decides to act as a relay, not the originator of the traffic.

It will be appreciated that, in another embodiment, the possible asymmetry that can exist in link states is considered. In fact, some nodes in the network may be constrained to operate at lower power levels, such as handheld or portable radios, in a network of higher-powered vehicle-mounted radios. Handheld radios or portable radios can easily hear transmissions from distant vehicle based nodes, but can only be heard by nodes that are close by.

Conversely, in some tactical situations where vehicle-mounted radios or handheld radios are collocated with radio jamming equipment, friendly or enemy operated, they must attempt to hear signals from other net members while positioned in an area of high radio interference. This situation has become prevalent in current military operations where radio nodes are collocated with a jammer that is used to jam radio signals used by enemy forces to detonate radio-controlled improvised explosive devices (IEDS or road-side bombs). Such jammers are referred to as counter improvised explosive devices jammers. The close proximity of such jammers to radio nodes, essentially collocated with them may cause significant local noise and interference impeding reception of signals from distant radio nodes. Again, asymmetric link conditions will prevail among some network members. The presence, character, and geolocation of such interference is easily known and can be included in the calculation of links states. Algorithms that compute members of the connected dominating set on the basis of such asymmetric situations are also included in this invention.

As a consequence, it is possible for each node to determine using the topology estimated whether or not it should be relaying traffic for other nodes. The computations are based on information that is generally available to most or all nodes. It may include information already included in user traffic, e.g., PA data, without specific exchanges of network management information among nodes. The exchange of network management data is replaced with stored knowledge of georeferenced elevation data and interference data and with computations that are easily met in modern software-defined or computer based radio equipment.

It will be appreciated that the method disclosed above may be easily implemented in a software-defined radio.

The skilled addressee will appreciate that most radios developed in the past few years fall into this category, including most radios developed for military or paramilitary use, and some for commercial or domestic use, including devices such as Smartphones, Iphones™, Blackberrys™, etc.

Alternatively, the software components of the method disclosed may be implemented in a compact portable computing device that can be connected to an existing radio via an available data port for instance.

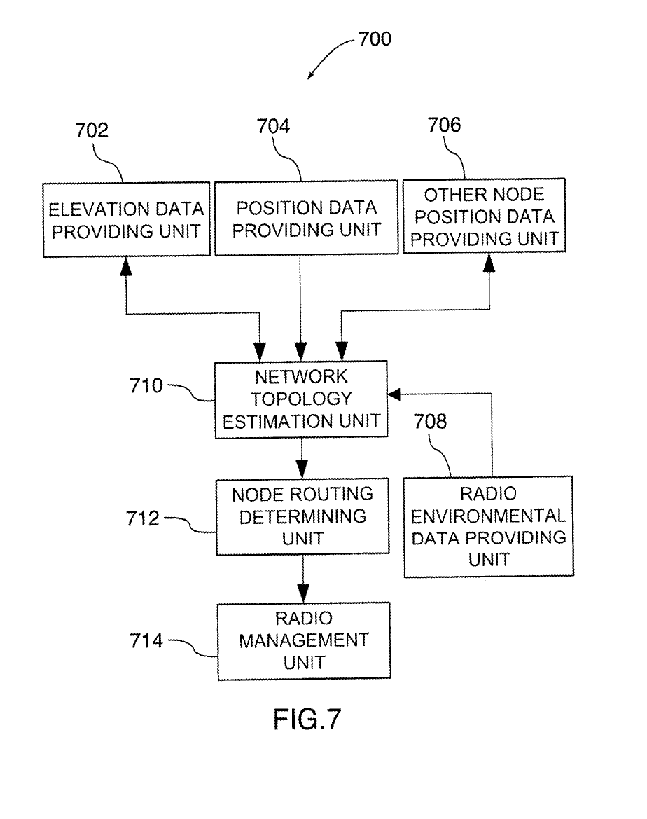

Now referring to FIG. 7, there is shown an embodiment of a system 700 which uses the method for estimating the topology of a network for the purpose of operating a radio.

The system 700 may be implemented, in one embodiment, in a software-defined radio.

It will be appreciated that, in this embodiment, the radio has a well defined media access control (MAC) protocol that determines from moment to moment which node can transmit on a common radio channel that is shared by all nodes.

Typically, this will be some form of time division multiple access (TDMA) protocol that is preferred for such radio networks. The media access control (MAC) protocol will provide some mechanism for apportioning available channel bandwidth to each user, which mechanism can be easily used to allocated bandwidth to nodes that assume a relay responsibility in addition to their support for sending and receiving traffic for local users. Most recently developed tactical radios offer such capabilities.

The system 700 comprises an elevation data providing unit 702, a position data providing unit 704, another node data position providing unit 706, a radio environmental data providing unit 708, a network topology estimation unit 710, a node routing unit 712 and a radio management unit 714.

The elevation data providing unit 702 is used for providing elevation data.

More precisely and in one embodiment, the elevation data providing unit 702 comprises a data file of georeferenced terrain elevation data that contains terrain elevation in meters over a grid of ‘post’ positions that have latitude and longitude values either directly, or as implied by the data structure.

It will be appreciated that standard Digital Terrain Elevation Data files readily available from government sources may be stripped of non-essential metadata and can be reduced in size by an order of magnitude making it easy to store large areas in the memory available in the software-defined radio. In fact, it will be appreciated that the basic Digital Terrain Elevation Data/Canadian Digital Elevation Data text files obtained from mapping agencies represent elevation information using 5 bytes per post, permitting a decimal representation of elevations from zero to 10,000 meters (Mt. Everest) with a resolution of 1 meter. This may easily be converted to a binary two-byte value with the same result. The post spacing may also be increased by a factor of two to four to reduce the number of elevation values stored for a given area of operations without materially affecting the effectiveness of the method disclosed herein.

In fact, increasing the post spacings by a factor of two in each direction, from 75 to 150 arc-seconds, reduces the number of values in a file by a factor of four. The two steps described above reduce the size of the file to ⅖×¼= 1/10 of the original file size. It will be appreciated that other reductions may be possible.

It will be appreciated that, in one embodiment, the elevation data is provided by the elevation data providing unit 702 in response to a request sent by the network topology estimation unit 710. The request may comprise a given latitude and longitude.

The system 700 further comprises a position data providing unit 704. The position data providing unit 704 is used for providing a position data of the node. It will be appreciated that the position data providing unit 704 may be of various types.

In one embodiment, the position data providing unit 704 comprises a global positioning system (GPS) receiver.

Alternatively, the position data providing unit 704 comprises a trilateration process, or a dead-reckoning navigation system.

In one embodiment, the position data is provided by the position data providing unit 704 to the network topology estimation unit 710 in response to a request from the network topology estimation unit 710. In an alternative embodiment, the position data is provided continuously by the position data providing unit 704 to the network topology estimation unit 710.

The other node position data providing unit 706 is used for providing the position of the other nodes of the network. It will be appreciated that the other node position data providing unit 706 obtains the position data from the various other nodes over a wireless link and then forwards them to the network topology estimation unit 710.

The radio environmental data providing unit 708 is used for providing radio environmental data associated with the given node.

The skilled addressee will appreciate that the data may be of various types as explained herein. For instance, the data may comprise information associated with a counter improvised explosive devices jammer located next to the given node.

The network topology estimation unit 710 is operatively connected, inter alia, to the elevation data providing unit 702, to the position data providing unit 704, to the other node position data providing unit 706, to the radio environmental data providing unit 708.

The network topology estimation unit 710 is capable of estimating a network topology for network. It will be appreciated that the network topology estimation unit 710 is continuously determining an estimation of the topology of the network.

The network topology estimation unit 710 is operatively connected to a node routing determining unit 712.

The node routing determining unit 712 is used for determining a routing table for the given node using the estimation of the topology of the network estimated by the network topology estimation unit 710. It will be appreciated by the skilled addressee that the determining of the routing table may comprise determining the nodes members of the connected dominating set and also determining whether the given node should be used as a gateway or not.

As mentioned above, certain algorithms may be used for determining the routing table for the given node using the estimation of the topology of the network.

It will be appreciated that the node routing determining unit 712 is continuously determining a node routing table.

The radio management unit 714 is used for managing the radio.

More precisely, the radio management unit 714 is operatively connected to the node routing determining unit 712.

The radio management unit 714 receives the routing table from the node routing and manages the radio accordingly.

More precisely, the radio management unit 714 interface with the radio's built-in control functions and will control whether the radio will act as a relay or not for other transmissions it receives.

It will be appreciated that a storage device is further disclosed for storing programming instructions executable by a processor. When executed, the programming instructions will cause the execution by the processor of a method for estimating, at a given node of a plurality of nodes located in a deployment zone and defining a radio network, the method comprising obtaining a position of the given node; obtaining a position of at least one other node from the plurality of nodes; obtaining elevation data in the deployment zone; for each two given nodes selected from a group consisting of the given node and the at least one node from the plurality of nodes; computing an estimate of a total radio path loss between the two given nodes using at least one part of the elevation data; comparing the computed estimate of the total radio path loss between the two given nodes and a corresponding maximum permissible path loss value between the two given nodes to determine if a given radio link between the two given nodes is possible; storing an indication of the possibility of having a radio link between the two given nodes and generating the estimation of the topology of the radio network using the stored indications of the possibility of having a radio link.

Although the above description relates to a specific embodiment as presently contemplated by the inventor, it will be understood that the invention in its broad aspect includes functional equivalents of the elements described herein.

Clause 1. A method for estimating, at a given node of a plurality of nodes located in a deployment zone and defining a radio network, a topology of the radio network, the method comprising:

obtaining a position of the given node;

obtaining a position of at least one other node from the plurality of nodes;

obtaining elevation data in the deployment zone;

for each two given nodes selected from a group consisting of the given node and the at least one node from the plurality of nodes;
computing an estimate of a total radio path loss between the two given nodes using at least one part of the elevation data;
comparing the computed estimate of the total radio path loss between the two given nodes and a corresponding maximum permissible path loss value between the two given nodes to determine if a given radio link between the two given nodes is possible;
storing an indication of the possibility of having a radio link between the two given nodes; and

generating the estimation of the topology of the radio network using the stored indications of the possibility of having a radio link.

Clause 2. The method as claimed in clause 1, wherein the obtaining of the position of the given node comprises receiving the position from a global positioning system (GPS) receiver.

Clause 3. The method as claimed in clause 1, wherein the obtaining of the position of the given node comprises performing a radio trilateration and providing a position resulting from the radio trilateration.

Clause 4. The method as claimed in clause 1, wherein the obtaining of the position of the given node comprises computing a position using dead-reckoning principles from a reference point.

Clause 5. The method as claimed in clause 1, wherein the indication of the possibility of having a radio link between the two given nodes comprises one of an indication that the radio link between the two given nodes is possible and an indication that the radio link between the two given nodes is not possible.

Clause 6. The method as claimed in clause 1, wherein the position of the given node is obtained locally.

Clause 7. The method as claimed in clause 1, wherein the position of the given node is obtained from a remote location.

Clause 8. The method as claimed in clause 1, wherein the obtaining of a position of at least one other node from the plurality of nodes comprises for each of the at least one other node obtaining a corresponding position and transmitting the corresponding position to the given node.

Clause 9. The method as claimed in clause 8, wherein the obtaining of a corresponding position comprises using a global positioning system (GPS) receiver.

Clause 10. The method as claimed in clause 8, wherein the obtaining of a corresponding position comprises performing a radio trilateration and providing a position resulting from the radio trilateration.

Clause 11. The method as claimed in any one of clauses 8 to 10, wherein the transmitting of the corresponding position to the given node comprises providing an identification of the corresponding node transmitting the corresponding position.

Clause 12. The method as claimed in clause 11, wherein the identification of the corresponding node comprises a media access control (MAC) address of the corresponding node.

Clause 13. The method as claimed in any one of clauses 1 to 12, wherein the obtaining of the elevation data comprises accessing a file with a corresponding position and obtaining a corresponding elevation data associated with the corresponding position.

Clause 14. The method as claimed in any one of clauses 1 to 13, wherein the estimate Plex of a total radio path loss between the two given nodes is equal to:

Plex=32.4+20×log(f)+20×log(D)+A(dB)+EX(dB),

wherein f is an operating frequency in MHz, D is a distance between the two given nodes in kilometres, A is an allowance for fading and EX is an excess loss value.

Clause 15. The method as claimed in clause 14, wherein the corresponding maximum permissible path loss value between the two given nodes is equal to:

Pl(max)=Pt−SNR(min)−No,

wherein Pt is a power transmitted, SNR(min) is a ratio of signal power to noise at a receiver and No is a level of noise present at a receiver.

Clause 16. A system for operating a radio at a given node of a plurality of nodes located in a deployment zone and defining a radio network, the system comprising:

an elevation data providing unit for providing elevation data for a given position;

a position data providing unit for providing a position of the given node;

a radio environmental data providing unit for providing radio environmental data associated with the given node;

a network topology estimation unit operatively connected to the elevation data providing unit, to the position data providing unit and to the radio environmental data providing unit, the network topology estimation unit obtaining the position of the given node from the position data providing unit; the network topology estimation unit further obtaining a corresponding position of at least one other node from the plurality of nodes; the network topology estimation unit further obtaining the elevation data in the deployment zone from the elevation data providing unit; for each two given nodes selected from a group consisting of the given node and the at least one node from the plurality of nodes, the network topology estimation unit computing an estimate of a total radio path loss between the two given nodes using at least one part of the elevation data, comparing the computed estimate of the total radio path loss between the two given nodes and a corresponding maximum permissible path loss value between the two given nodes to determine if a given radio link between the two given nodes is possible and storing an indication of the possibility of having a radio link between the two given nodes to provide an estimation of a network topology;

a node routing determining unit operatively coupled to the network topology estimation unit and, the node routing determining unit for generating a routing table using the estimation of a network topology; and

radio management unit operatively connected to the node routing determining unit, the radio management unit for managing the radio using the estimation of the network topology.

Clause 17. The system as claimed in clause 16, wherein the position data providing unit comprises a global positioning system (GPS) receiver.

Clause 18. The system as claimed in any one of clauses 16 to 17, wherein the routing table determined by the node routing determining unit comprises an indication of at least one node member of a connected dominating set.

Clause 19. The system as claimed in any one of clauses 16 to 17, wherein the routing table determined by the node routing determining unit comprises an indication that the given node is a gateway.

Clause 20. A storage device for storing programming instructions executable by a processor, which when executed will cause the execution by the processor of a method for estimating, at a given node of a plurality of nodes located in a deployment zone and defining a radio network, the method comprising obtaining a position of the given node; obtaining a position of at least one other node from the plurality of nodes; obtaining elevation data in the deployment zone; for each two given nodes selected from a group consisting of the given node and the at least one node from the plurality of nodes; computing an estimate of a total radio path loss between the two given nodes using at least one part of the elevation data; comparing the computed estimate of the total radio path loss between the two given nodes and a corresponding maximum permissible path loss value between the two given nodes to determine if a given radio link between the two given nodes is possible; storing an indication of the possibility of having a radio link between the two given nodes and generating the estimation of the topology of the radio network using the stored indications of the possibility of having a radio link.

1. A method for estimating, at a given node of a plurality of nodes located in a deployment zone and defining a radio network, a topology of the radio network, the method comprising:
obtaining a position of the given node;
obtaining a position of at least one other node from the plurality of nodes;
obtaining elevation data in the deployment zone;
for each two given nodes selected from a group consisting of the given node and the at least one node from the plurality of nodes:
computing an estimate of a total radio path loss between the two given nodes using at least one part of the elevation data,
comparing the computed estimate of the total radio path loss between the two given nodes and a corresponding maximum permissible path loss value between the two given nodes to determine if a given radio link between the two given nodes is possible, and
storing an indication of the possibility of having a radio link between the two given nodes;
generating the estimation of the topology of the radio network using the stored indications of the possibility of having a radio link.

2. The method as claimed in claim 1, wherein the obtaining of the position of the given node comprises receiving the position from a global positioning system (GPS) receiver.

3. The method as claimed in claim 1, wherein the obtaining of the position of the given node comprises performing a radio trilateration and providing a position resulting from the radio trilateration.

4. The method as claimed in claim 1, wherein the obtaining of the position of the given node comprises computing a position using dead-reckoning principles from a reference point.

5. The method as claimed in claim 1, wherein the indication of the possibility of having a radio link between the two given nodes comprises one of an indication that the radio link between the two given nodes is possible and an indication that the radio link between the two given nodes is not possible.

6. The method as claimed in claim 1, wherein the position of the given node is obtained locally.

7. The method as claimed in claim 1, wherein the position of the given node is obtained from a remote location.

8. The method as claimed in claim 1, wherein the obtaining of a position of at least one other node from the plurality of nodes comprises for each of the at least one other node obtaining a corresponding position and transmitting the corresponding position to the given node.

9. The method as claimed in claim 8, wherein the obtaining of a corresponding position comprises using a global positioning system (GPS) receiver.

10. The method as claimed in claim 8, wherein the obtaining of a corresponding position comprises performing a radio trilateration and providing a position resulting from the radio trilateration.

11. The method as claimed in claim 8, wherein the transmitting of the corresponding position to the given node comprises providing an identification of the corresponding node transmitting the corresponding position.

12. The method as claimed in claim 11, wherein the identification of the corresponding node comprises a media access control (MAC) address of the corresponding node.

13. The method as claimed in claim 1, wherein the obtaining of the elevation data comprises accessing a file with a corresponding position and obtaining a corresponding elevation data associated with the corresponding position.

14. The method as claimed in claim 1, wherein the estimate Plex of a total radio path loss between the two given nodes is equal to:
Plex=32.4+20×log(f)+20×log(D)+A(dB)+EX(dB),
wherein f is an operating frequency in MHz, D is a distance between the two given nodes in kilometres, A is an allowance for fading and EX is an excess loss value.

15. The method as claimed in claim 14, wherein the corresponding maximum permissible path loss value between the two given nodes is equal to:
Pl(max)=Pt−SNR(min)−No,
wherein Pt is a power transmitted, SNR(min) is a ratio of signal power to noise at a receiver and No is a level of noise present at a receiver.

16. A system for operating a radio at a given node of a plurality of nodes located in a deployment zone and defining a radio network, the system comprising:
an elevation data providing unit for providing elevation data for a given position;
a position data providing unit for providing a position of the given node;
a radio environmental data providing unit for providing radio environmental data associated with the given node;
a network topology estimation unit operatively connected to the elevation data providing unit, to the position data providing unit and to the radio environmental data providing unit, the network topology estimation unit obtaining the position of the given node from the position data providing unit; the network topology estimation unit further obtaining a corresponding position of at least one other node from the plurality of nodes; the network topology estimation unit further obtaining the elevation data in the deployment zone from the elevation data providing unit; for each two given nodes selected from a group consisting of the given node and the at least one node from the plurality of nodes, the network topology estimation unit computing an estimate of a total radio path loss between the two given nodes using at least one part of the elevation data, comparing the computed estimate of the total radio path loss between the two given nodes and a corresponding maximum permissible path loss value between the two given nodes to determine if a given radio link between the two given nodes is possible and storing an indication of the possibility of having a radio link between the two given nodes to provide an estimation of a network topology;
a node routing determining unit operatively coupled to the network topology estimation unit and, the node routing determining unit for generating a routing table using the estimation of a network topology; and
radio management unit operatively connected to the node routing determining unit, the radio management unit for managing the radio using the estimation of the network topology.

17. The system as claimed in claim 16, wherein the position data providing unit comprises a global positioning system (GPS) receiver.

18. The system as claimed in claim 16, wherein the routing table determined by the node routing determining unit comprises an indication of at least one node member of a connected dominating set.

19. The system as claimed in claim 16, wherein the routing table determined by the node routing determining unit comprises an indication that the given node is a gateway.

20. A storage device for storing programming instructions executable by a processor, which when executed will cause the execution by the processor of a method for estimating, at a given node of a plurality of nodes located in a deployment zone and defining a radio network, the method comprising obtaining a position of the given node; obtaining a position of at least one other node from the plurality of nodes; obtaining elevation data in the deployment zone; for each two given nodes selected from a group consisting of the given node and the at least one node from the plurality of nodes; computing an estimate of a total radio path loss between the two given nodes using at least one part of the elevation data; comparing the computed estimate of the total radio path loss between the two given nodes and a corresponding maximum permissible path loss value between the two given nodes to determine if a given radio link between the two given nodes is possible; storing an indication of the possibility of having a radio link between the two given nodes and generating the estimation of the topology of the radio network using the stored indications of the possibility of having a radio link.
